(19) United States
(12) Patent Application Publication
(10) Pub. No.: US 2010/0278347 A1
(43) Pub. Date: Nov. 4, 2010

(54) ACOUSTIC HOSTILE FIRE INDICATOR

(75) Inventors: George SUCCI, Merrimack, NH (US); Eldon M. Sutphin, Merrimack, NH (US); Edward C. Real, Nashua, NH (US); Philip J. Haney, Merrimack, NH (US); William O. Devine, Stoneham, MA (US)

Correspondence Address: BAE SYSTEMS, PO BOX 868, NASHUA, NH, 03061-0868, US

(73) Assignee: BAE Systems Information and Electronic Systems Integration Inc., Nashua, NH (US)

(21) Appl. No.: 12/632,441

(22) Filed: Dec. 7, 2009

Related U.S. Application Data
(60) Provisional application No. 61/193,544, filed on Dec. 5, 2008.

(51) Int. Cl. H04R 29/00

(52) U.S. Cl. 381/56

(57) ABSTRACT

A system for detecting of the location of shooters with respect to a moving platform is disclosed and claimed. The system makes use of the ballistic shock of ordnance to find a shooter by one of three methods: using a single small array (that detects ordnance shock) in conjunction with the electro-optic infrared detection of the shot; using a single small array that detects both the muzzle blast (often obscured on an aircraft in flight) and ordnance shock (that is more easily detected above the background noise); and using multiple small arrays, each of which detects ordnance shock, to triangulate the ordnance trajectory.

### RELATED APPLICATIONS

This application claims rights under 35 USC §119(e) from U.S. Provisional Application No. 61/193,544, filed Dec. 5, 2008, the contents of which are incorporated herein by reference.

### BACKGROUND OF THE INVENTION

1. Field of the Invention

The present invention relates to detecting the location of a source of audible and thermal energy, and, more particularly, the present invention relates to detecting the location of a shooter from a moving vehicle such as a helicopter.

2. Description of the Related Art

In certain circumstances and areas, such as within a combat zone, it becomes necessary to detect when a projectile is being directed at you. Early and accurate detection allows one to avoid the projectile if possible, and to move to a safer location to avoid being impacted with further projectiles. It is further beneficial to determine the location from where the projectile originated, and to do so as quickly and accurately.

One known system for detecting inbound projectiles is known as the Common Missile Warning System (“CMWS”). This system senses ultraviolet missile detection data from electro-optic missile sensors and sends a missile alert signal to on-board avionics. The CMWS can function as a stand-alone system with the capability to detect missiles and provide audible and visual warnings to pilots. It can be used in conjunction with other systems, such as to activate expendables to decoy/defeat infrared-guided missiles.

The present invention improves upon the known technology by adding another layer of detection that may be used independently or in conjunction with existing detection systems.

### SUMMARY OF THE INVENTION

The system of the present invention provides for the detection of the location of shooters with respect to a moving platform, such as a helicopter or fixed-wing aircraft. The system makes use of the ballistic shock of ordnance to find a shooter by one of three methods: using a single small array (that detects ordnance shock) in conjunction with the electro-optic infrared detection of the shot; using a single small array that detects both the muzzle blast (often obscured on an aircraft in flight) and ordnance shock (that is more easily detected above the background noise); and using multiple small arrays, each of which detects ordnance shock, to triangulate the ordnance trajectory.

### DESCRIPTION OF THE DRAWINGS

The present invention is described with reference to the accompanying drawings, wherein:

FIG. 1 shows a back view of a housing for a microphone array of the present invention;

FIG. 2 shows an exploded view of the microphone array of FIG. 1 in position with other detection system components;

FIG. 3 shows an assembled back view of the systems of FIG. 2;

FIG. 4 shows a front view of the systems of FIG. 2;

FIG. 5 shows an exemplary scenario of how the present invention may be used;

FIG. 6 shows a schematic of how the range to a shooter is determined; and

FIG. 7 shows a processing chain of the present invention.

### DETAILED DESCRIPTION OF THE INVENTION

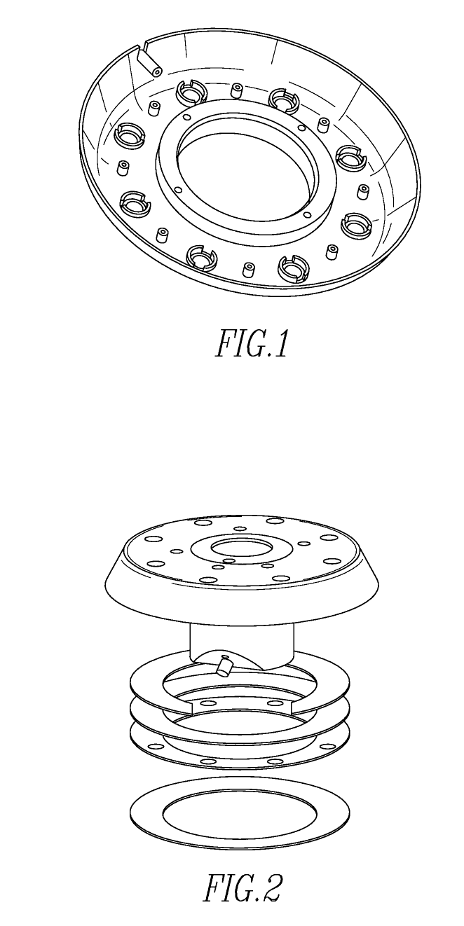

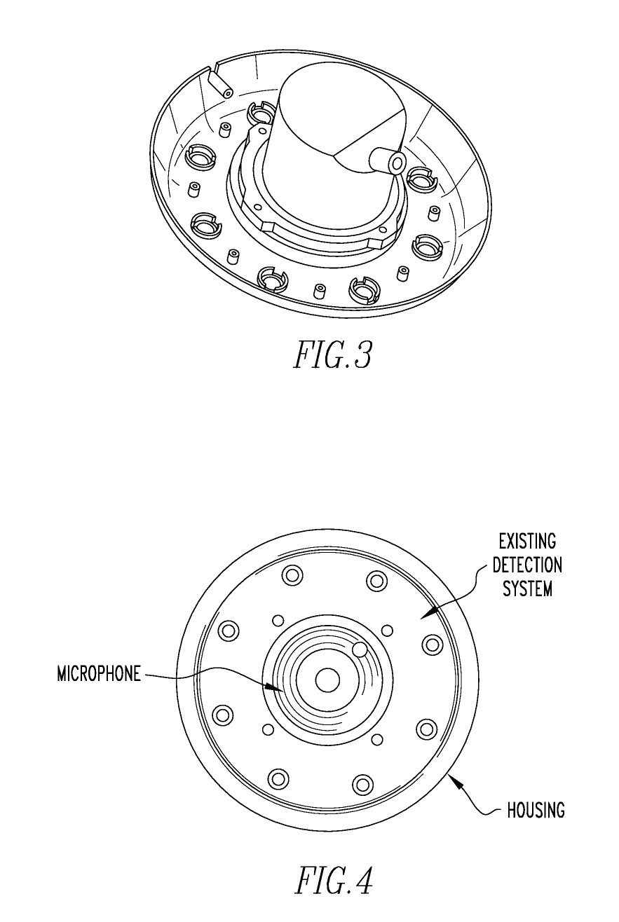

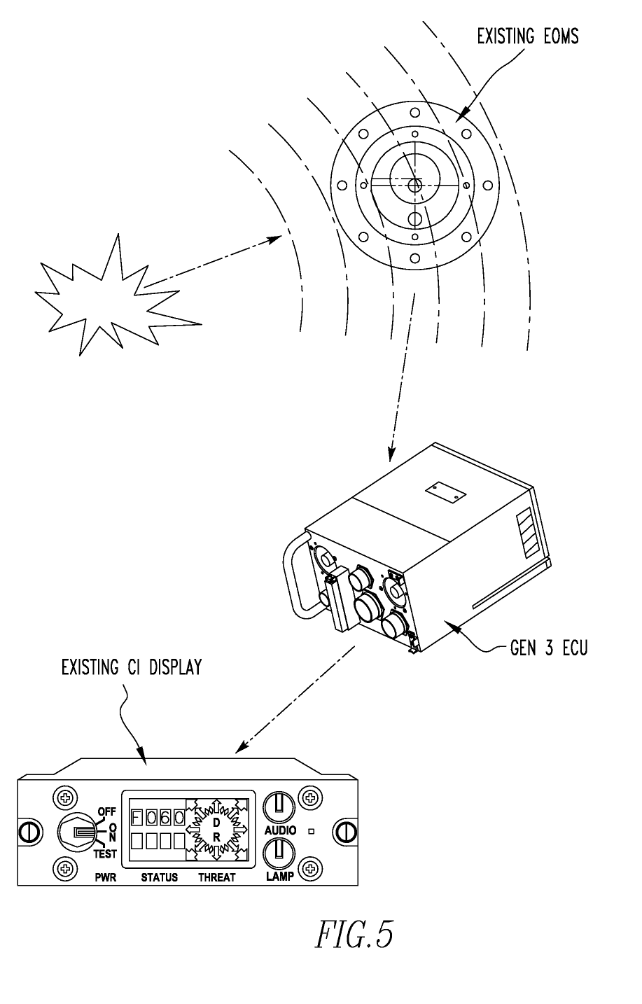

The system of the present invention provides for the detection of the location of shooters with respect to a moving platform, such as a helicopter or fixed-wing aircraft. The system detects the acoustic emissions of a weapon being fired, and accurately determines the location of the shooter. The system includes an array of microphones that are placed within a housing, which is then positioned on the outer surface of the vehicle. A lower surface of the vehicle is a preferred attachment location. The microphones preferably are positioned in a circular array. FIG. 1 shows a back view of a housing for the microphone array. The housing protects the microphones and the associated electronics while also retaining the microphones in the appropriate location. In one preferred embodiment, the acoustic sensor system of the present invention is used in conjunction with existing detection systems, such as CMWS. FIG. 2 shows an exploded view of the microphone array of FIG. 1 in position with a CMWS system. In this illustrated arrangement, the housing is positioned on an outer periphery of the detection components of the existing system. FIG. 3 shows an assembled back view of the system of FIG. 2. FIG. 4 shows a front view of the systems of FIG. 2. The housing surrounds the components of the existing system but does not interfere or obscure these components.

The inventive system further comprises electronics to process the information detected by the microphones. Such equipment may include filters to block or remove background noise and other unwanted data. Such equipment may also include processors to match the detected acoustic data to known or expected acoustic profiles. Such equipment may also include processors to perform calculations to determine the angle of arrival (“AOA”) and time of arrival (“TOA”) of the ordnance. Such equipment may also include signaling electronics to deliver the detected and calculated data to the vehicle operator and/or other personnel. The system may make use of alarming equipment already on board the vehicle, such as that associated with the CMWS system. The electronic equipment may also be positioned within the annular housing. Thus, the entire inventive system is small and light, weighing only a few pounds, minimizing installation and operational burden to the vehicle.

FIG. 5 shows an exemplary scenario of how the present invention may be used. At point 1, a weapon is fired. The microphones of the present invention detect the shock wave generated by the ordnance as it passes through the air. Once the acoustic data has been received, it is processed by the electronic equipment. Exemplary processing steps include filtering noise from the measured data, convolving the data to remove statistical scatter, determining the timing of measurement for each microphone within the array, and calculating the position of the shooter. This determined information, which can be used in conjunction with information processed by other systems of the vehicle, is then provided to the vehicle operator.

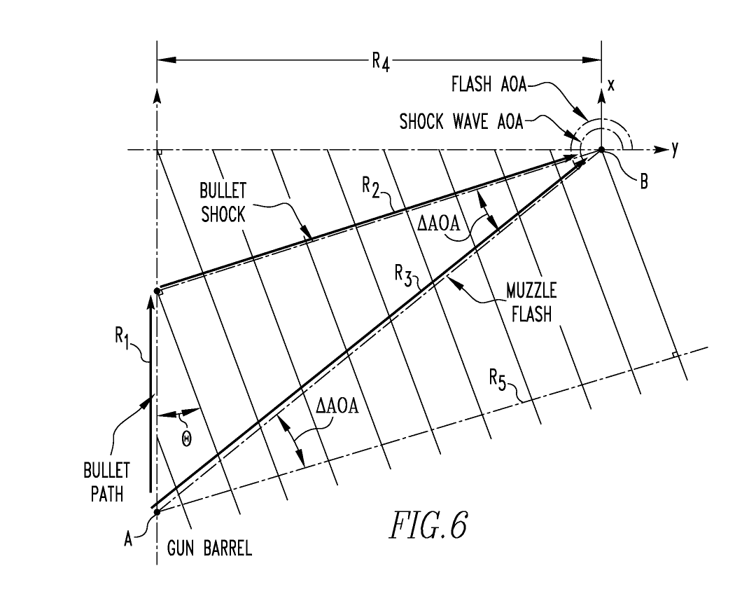

FIG. 6 shows a schematic diagram of how the range to a shooter is determined. In this illustrated example, the ordnance is fired from a weapon illustrated in the lower left corner of the illustration at point A. The vehicle and inventive sensor system are positioned in the upper right corner of the illustration at point B. While the projectile is traveling vertically upwards in the figure, the system may be used regardless of the direction of travel of the ordnance and/or the vehicle. The flash generated by the firing of the projectile is detected by the ultraviolet sensors of the CMWS, which determines the AOA and TOA of the flash. The acoustic emissions of the traveling ordnance are detected by the inventive system, which calculates the AOA and TOA of the ordnance. Together this data allows accurate computation of the range to the weapon location:

$$Range to weapon = {R}_{3} \begin{matrix}= \frac{{R}_{5}}{cos ( {AOA}_{flash} - {AOA}_{shock} )} \\ = \frac{c \cdot ( {TOA}_{shock} - {TOA}_{flash} )}{cos ( {AOA}_{flash} - {AOA}_{shock} )} \\ = \frac{c \cdot Δ TOA}{cos ( Δ AOA )}\end{matrix}$$

In the above equations, c is the speed of sound. Thus, by measuring both the optical and acoustic measurements of the ordnance, not only the direction to the shooter but also the distance to the shooter are determined. These equations were described by R. C. Maher in “Modeling and Signal Processing of Acoustic Gunshot Recordings,” Proc. IEEE Signal Processing Society 12th DSP Workshop, pp. 257-261, September 2006, Jackson Lake, Wyo.

While the above discussion refers to muzzle blast, the second signal may be detected via electro-optic infrared detection. This information will be used in conjunction with the acoustic detection of the shot as described above to determine the location of the shooter.

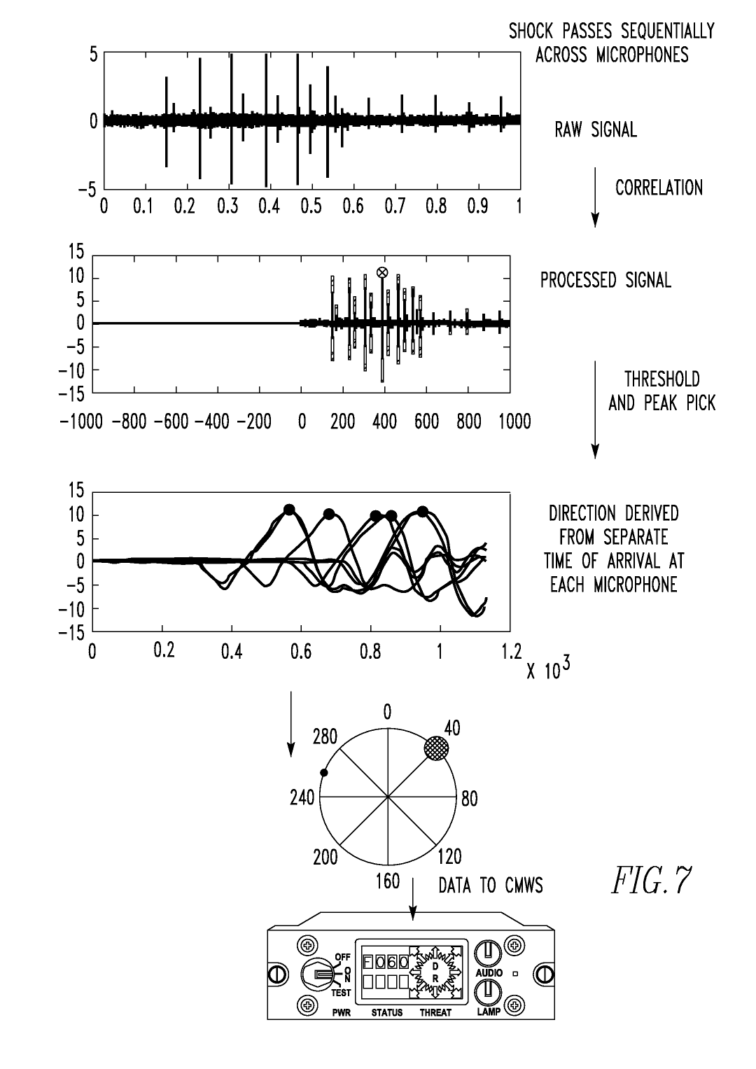

FIG. 7 shows a processing chain of the present invention. The sequence begins at the top of the page and flows downward as indicated by the arrows. Initially, acoustic data of inbound ordnance is measured. The uppermost chart of measured data reveals six major spikes. Each spike corresponds to the ballistic shock wave created by the ordnance moving at supersonic speed. Thus, the first chart of FIG. 7 shows that six shots were fired. Each of these six major spikes is followed by a smaller peak shortly thereafter. These shorter peaks correspond to echoes of the shock waves bouncing off the ground. Furthermore, additional peaks are shown as being measured later in time. This second set of smaller peaks corresponds to the acoustic energy of the shot being fired, which arrived at the microphone array after the fast traveling ordnance.

After the data is measured, it is processed or filtered to remove background noise. The processed signal is shown in the second chart of FIG. 7. One source of background noise is the sounds generated by operation of the vehicle itself. Another major source of background noise is air flow, caused by vehicle movement, against the microphones. Thus, the microphones should be selected or adjusted to minimize this noise source as much as possible. The data of FIG. 7 was measured in a hovering helicopter, which significantly reduced the amount of air flow noise.

The processed signal is then correlated or convoluted. This step is also known as match filtering. This step compares the processed signal to known or expected acoustic profiles for ordnance to further remove noise such as statistical scatter from the data. The result of this convolution process is a substantially clear acoustic signal of the ballistic shock wave from which calculations can be made. The third chart in the sequence of FIG. 7 is a magnified view of the encircled fourth peak of the second chart of the sequence after convolution. This chart shows the ballistic shock measurement made by each microphone within the array for a single bullet. The peak of each microphone's measurement have been noted, indicating the time at which each microphone within the array sensed the ballistic shock.

The difference in timing among the microphones within the array indicates from which direction the projectile came. Thus, the direction to the weapon and shooter is determined. This angular calculation is illustrated in the fourth chart in the sequence of FIG. 7. Here, it has been determined that the measured shots approached the vehicle at a 45° angle. This data is then transmitted to the vehicle operator in the final step in the sequence of FIG. 7.

In another preferred embodiment, the acoustic sensor system of the present invention is used without the input of any other detection system. With this design, multiple arrays are used to provide multiple signals that are triangulated to yield the location of the weapon and the inbound ordnance.

The use of the terms “a” and “an” and “the” and similar references in the context of describing the invention are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. For example, while the invention has been described herein as being used with an aircraft it may also be used on other platforms, such as a ground vehicle. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

Additional information regarding the invention is attached hereto as Exhibit A.

What is claimed is:

1. A system for detecting the location of a source of audible and thermal energy, comprising:
a housing;
a plurality of microphones coupled to said housing to detect acoustic data;
a processor coupled to each of said plurality of microphones, said processor containing a memory configured to hold computer-readable instructions including instructions for causing the system to:
filter background noise;
convolve the detected acoustic data based on a known or expected acoustic profile;
calculate the angle of arrival and time of arrival of a source of the acoustic data; and
generate an alarm signal.

2. A method of determining the location of a source of audible and thermal energy, comprising:
measuring acoustic data from the source;
calculating the angle of arrival and time of arrival of the measured acoustic data to create calculated acoustic data;
measuring optical data from the source;
calculating the angle of arrival and time of arrival of the measured optical data to create calculated optical data;
determining the location of the source based on the calculated acoustic and calculated optical data.
